(19) United States
(12) Patent Application Publication
(10) Pub. No.: US 2006/0245327 A1
(43) Pub. Date: Nov. 2, 2006

(54) Optical information writing apparatus and method

(76) Inventors: Toskiaki Suzuki, Tokohama-si (JP); Toru Yoshida, Tokohama-si (JP); Shin Kagami, Tokohama-si (JP); Harutaka Sekiya, Tokohama-si (JP)

Correspondence Address: LEE & MORSE, P.C., 3141 FAIRVIEW PARK DRIVE, SUITE 500, FALLS CHURCH, VA, 22042, US

(21) Appl. No.: 11/413,009

(22) Filed: Apr. 28, 2006

(30) Foreign Application Priority Data
Apr. 28, 2005 (JP) 2005-131851

(51) Int. Cl. G11B 7/0045

(52) U.S. Cl. 369/59.11

(57) ABSTRACT

An optical information writing apparatus includes a written state determination unit and a write strategy setting unit. The written state determination unit determines whether an area of an optical recording medium in which information is to be recorded is used or blank. The write strategy setting unit sets a write strategy in accordance with whether the area is used or blank. When the area is used, the write strategy setting unit performs an overwrite operation before setting the write strategy.

### BACKGROUND OF THE INVENTION

1. Field of the Invention

The present invention relates to an optical information writing apparatus. More particularly, the present invention relates to an optical information writing apparatus and a method which can set a write strategy when an overwrite operation is performed.

2. Description of the Related Art

As internet use has rapidly become widespread, due to recent developments in information communication technologies, a huge amount of information is now exchanged through networks. Accordingly, write-once optical disks, such as a CD-R, and rewritable optical disks, such as a CD-RW, have been highlighted as recording media for information writing apparatuses.

As the wavelength of light sources used with optical disks has been shortened, a spot diameter has been reduced using an objective lens having a high numerical aperture (NA) and thin substrates have been employed, allowing high-capacity optical disks to be realized. High capacity optical disks, e.g., DVD-R, DVD-RW and DVD-RAM, are now in wide use as information recording media.

Generally, when information is recorded on an optical disk, such as a CD-R, recording information, e.g., from a personal computer (PC), is converted into an eight-to-fourteen modulation (EFM) signal and then is recorded on the optical disk. However, due to different compositions in color recording layers forming the optical disk, thermal storage or cooling rates of the optical disk may be insufficient to prevent pits being formed without defects. As a result, although the EFM signal is recorded without any change, a desired pit or land cannot be accurately formed.

In order to solve this problem, a high write quality may be maintained by setting a recording parameter (hereinafter referred to as “a write strategy”) unique to an individual optical disk, with respect to a reference write waveform. Representative write strategies include varying the ratio of pits and lands, adding an additional pulse to the front end of a writing pulse, changing a rising or falling position of a pulse with a combination of a pit and a land, and converting a write pulse into multiple pulses.

Setting of these write strategies may be performed by forming pits and lands in a test recording area of an optical recording medium with a standard write strategy (hereinafter referred to as “a reference write strategy”) and adjusting a pulse width or write power according to the recording quality of the area. However, write strategies are dependent on a recording speed as well as the color of the optical disk, phase change material, thickness of a color film or shape of a groove. Accordingly, a technology for setting a write strategy with respect to the recording speed has been suggested.

Rewritable optical disks are generally guaranteed to function for one thousand overwrite operations. However, when overwrites are performed according to an identical write strategy, the recording quality may be affected by the number of previous overwrite operations.

In order to solve this problem, an optical disk on which information is desired to be written is identified as a blank disk (on which information has not been written) or a used disk (on which information has already been written). A write power for a blank disk is set to be lower than that for a used disk so that the recording quality can be improved. However, since a jitter value, i.e., a measure of the recording quality, depends on the difference between a theoretical value of each pit or land and the length of a written pit or land, the recording quality cannot be sufficiently improved by only adjusting a write power.

### SUMMARY OF THE INVENTION

The present invention provides an optical information writing apparatus and method, which overcome one or more of the disadvantages of the related art.

It is therefore a feature of an embodiment of the present invention to provide an optical information writing apparatus capable of setting an optimum write strategy when an overwrite operation is performed on a used area of a recording medium.

It is therefore another feature of an embodiment of the present invention to an optical information writing method capable of setting an optimum write strategy when an overwrite operation is performed on a used area of a recording medium.

At least one of the above and other features and advantages of the present invention may be realized by providing an optical information writing method including determining a written state of an area of an optical recording medium in which information is to be recorded and setting a write strategy in accordance with the written state of the area to be recorded.

At least one of the above and other features and advantages of the present invention may be realized by providing an optical information writing apparatus including a written state determination unit for determining a written state of an area of an optical recording medium in which information is to be recorded and a write strategy setting unit for setting a write strategy in accordance with the written state of the area to be recorded.

At least one of the above and other features and advantages of the present invention may be realized by providing an article of manufacture having a machine-accessible medium including data that, when accessed by a machine, cause the machine to operate an optical information recording apparatus, the operation including determining a written state of an area of an optical recording medium in which information is to be recorded and setting a write strategy in accordance with the written state of the area to be recorded.

When the written state of the area is used, an overwrite operation may be performed before setting the write strategy. The overwrite operation may include overwriting information in a test recording area of the optical recording medium. The overwrite operation may include overwriting information on the used area in which information is to be recorded. The method may include determining a write power. The write power may occur before performing the overwrite operation.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a block diagram of an optical information writing apparatus according to an embodiment of the present invention;

FIG. 2 illustrates a timing diagram of a write strategy for a DVD-RW according to an embodiment of the present invention;

FIG. 3 illustrates a flowchart of an optical information writing method according to an embodiment of the present invention;

FIG. 4 illustrates a graph of effects to other pits when the length of a 3 T pit or a 6 T pit is changed according to an embodiment of the present invention;

FIG. 5 illustrates an optimum write strategy with respect to the frequency of an overwrite operation according to an embodiment of the present invention; and

FIG. 6 illustrates changes in jitter values when information is recorded according to a write strategy as shown in FIG. 5 according to an embodiment of the present invention.

### DETAILED DESCRIPTION OF THE INVENTION

Japanese Patent Application No. 2005-131851, filed on Apr. 28, 2005, in the Japanese Intellectual Property Office, and entitled: “OPTICAL INFORMATION WRITING APPARATUS AND METHOD,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Generally, when information is overwritten on a rewritable optical recording medium, the recording quality is degraded. The degradation of the recording quality arises due to a phenomenon whereby the absorption rate of light by a crystalline part of an optical recording medium on which information has not been recorded is different from that of a non-crystalline part of the optical recording medium on which information has already been recorded.

In accordance with an embodiment of the present invention, information may actually be overwritten in a predetermined region of an optical recording medium and an optimum write strategy for an overwrite operation is set based on the overwritten information such that the degradation of the quality of recording that occurs when an overwrite operation is performed can be prevented.

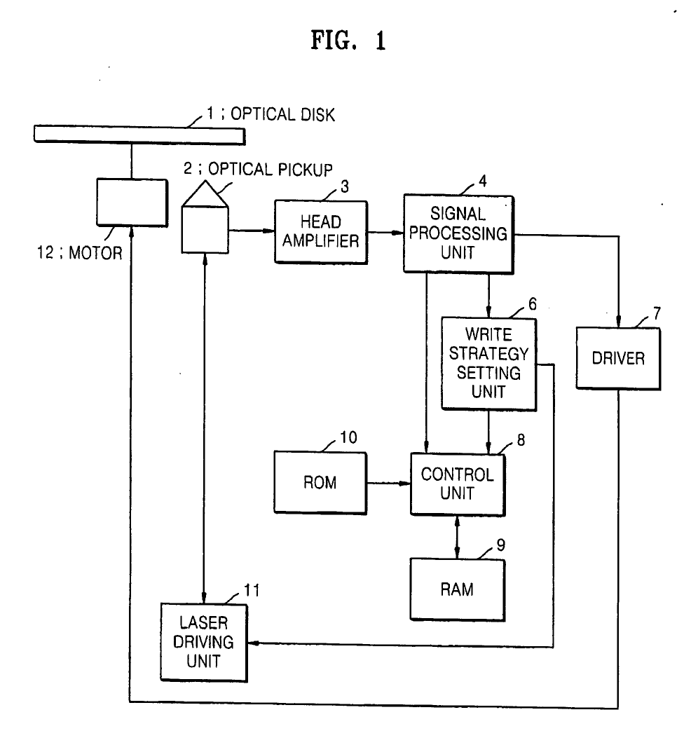

Referring to FIGS. 1 through 6, an optical information write apparatus and method according to an embodiment of the present invention will now be explained in detail. Although a DVD-RW is provided as an example of a rewritable optical recording medium hereinafter, a person skilled in the art of the present invention will appreciate that the present invention can be applied to other optical recording media.

FIG. 1 illustrates a block diagram of an optical information writing apparatus according to an embodiment of the present invention. The optical information writing apparatus may include an optical disk 1, an optical pickup 2, a head amplifier 3, a signal processing unit 4, a write strategy setting unit 6, a driver 7, a control unit (write state determination unit) 8, a RAM 9, a ROM 10, a laser driving unit 11 and a motor 12.

The optical disk 1 may be an optical recording medium on which recording, reproducing and deleting information may be performed by a light source, e.g., a semiconductor laser. In the embodiment of the present invention, it is assumed that the optical disk 1 is a DVD-RW.

The optical pickup 2 may include a light source (not shown), e.g., a laser diode and other known optical components (not shown). These optical components may include, e.g., a collimating lens, an objective lens driven by a focus actuator or a tracking actuator, a polarized beam splitter, a cylindrical lens, a 4-division photo detector (PD) with four (4) divided regions A, B, C and D, a 2-division PD and/or a monitor detector monitoring light output from the light source.

The head amplifier 3 may detect light reflected from the optical disk 1, calculate the amount of the reflected light and generate a radio frequency (RF) signal indicating the sum of the light reflected from regions of the 4-division PD. The head amplifier 3 may also generate a focus error signal that indicates misalignment of the focus of light output from the optical pickup 2, by, e.g., an astigmatism method. Furthermore, the head amplifier 3 may generate a tracking error (TE) signal, i.e., a signal detecting track distraction of light output from the optical pickup 2, by, e.g., a push-pull method.

The signal processing unit 4 may generate an EFM signal from the RF signal generated by the head amplifier 3. In the present embodiment of the present invention, the control unit 8 (a written state determination unit) may determine whether or not information has already been written in an area in which information is desired to be written based on a signal reproduced in the signal processing unit 4.

The write strategy setting unit 6 may compare an EFM signal extracted from information recorded according to a reference write strategy by the signal processing unit 4 with theoretical lengths of each pit and land, and may set an appropriate write strategy based on the difference value (hereinafter referred to as “a deviation value”) between the two values and probabilities of the presence of each pit and land.

The driver 7 may amplify a servo signal generated in the head amplifier 3 and the signal processing unit 4, and may provide a control signal to the motor 12, e.g., a focus actuator, a tracking actuator, a carriage motor and/or a spindle motor.

The control unit 8 may control the entire optical information writing apparatus according to a control program. The control unit 8 may determine whether or not information has already written in an area in which information is desired to be written based on the control signal input from the signal processing unit 4. If information has already been written in the area, the control unit 8 may control an operation to set a write strategy for an overwrite operation.

The RAM 9 may store deviation values used by the write strategy setting unit 6. The ROM 10 may store a control program to control the entire optical information writing apparatus or may reference a table of write strategies, the theoretical length of each pit and land, or the probability of a presence of a combination of each pit and land.

The laser driving unit 11 may generate a pulse signal for driving the light source based on the write strategy input from the write strategy setting unit 6 and may provide the signal to the light source in the optical pickup 2.

Next, a method of setting a write strategy according to an embodiment of the present invention will be explained. Here, a write strategy is defined in each recording medium.

In the case of a DVD-RW, a 1 T multi-pulse write strategy may be used for low recording speeds, e.g., equal to or less than a 4× speed, and a 2 T multi-pulse write strategy may be used for high recording speeds, e.g., equal to or higher than a 4× speed.

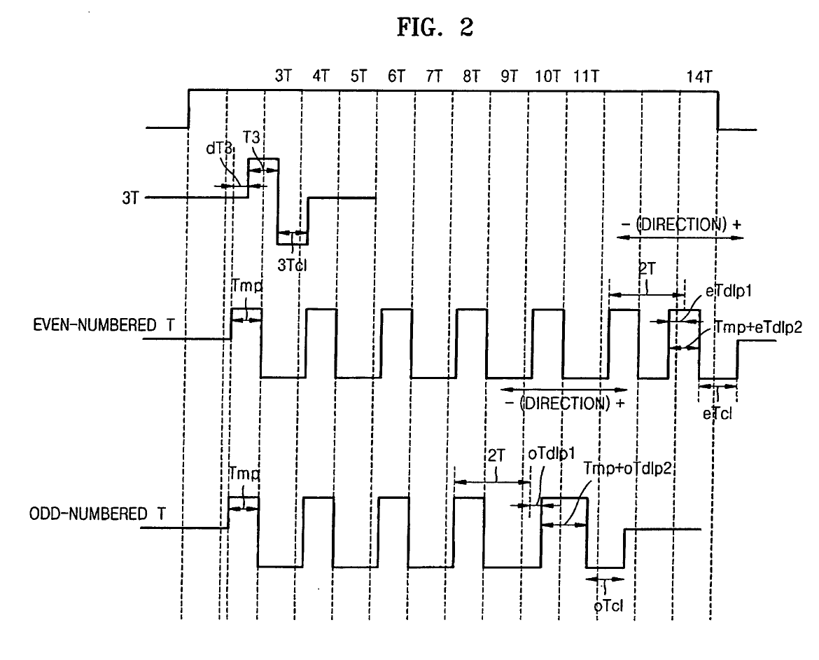

FIG. 2 illustrates a timing diagram of a 2 T multi-pulse write strategy for a DVD-RW according to an embodiment of the present invention.

Setting of a write strategy with respect to each of 3 T, even-numbered T and odd-numbered T is also possible.

Referring to FIG. 2, dT3 is a shift amount of 3 T, T3 is a pulse width of the 3 T, Tmp is a width of a multi pulse, eTdlp1 is a shift amount of a final even pulse for the even-numbered pulses, Tmp+eTdlp2 is a pulse width of the final even pulse, eTcl is an off pulse width of the final even pulse, oTdlp1 is a shift amount of a final odd pulse for the odd-numbered pulses, Tmp+oTdlp2 is a pulse width of the final odd pulse, and oTcl is an off pulse width of the final odd pulse. These values can be set. The multi pulse width Tmp is common to all.

Among these parameters, T3, eTdlp1, Tmp+eTdlp2, oTdlp1, and Tmp+oTdlp2 in particular are closely related to recording quality.

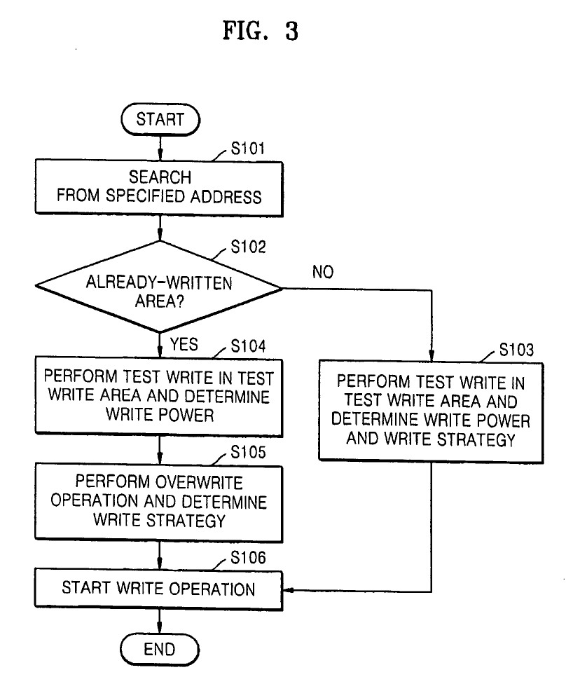

Accordingly, a method of setting these values will now be explained with reference to FIG. 3.

FIG. 3 illustrates a flowchart of an optical information writing method according to an embodiment of the present invention.

A write address is specified in a write mode. Accordingly, the control unit 8 may move the optical pickup 2 and may command the optical pickup 2 to perform a search operation at the specified write address in operation S101. When the light output from the optical pickup 2 arrives at the specified address, a signal at the specified address may be reproduced. The signal read by the optical pickup 2 may be output to the control unit 8 through the head amplifier 3 and the signal processing unit 4. Based on this signal, the control unit 8 may determine whether or not information has been recorded in a recording area of the specified address in operation S102.

If the control unit 8 determines that the area in which information is desired to be written is blank, i.e., on which information has not been written, an optimum write power to be used on the recording medium may be set by performing a test write according to a reference write strategy at a test recording area of an inner circumference of the recording medium in operation S103. Also, an optimum write strategy may be set according to a method explained below in operation S103.

If the control unit 8 determines that the area in which information is desired to be written is used, i.e., on which information has already been written, an optimum write power to be used on the recording medium may be set by performing a test write according to a reference write strategy at a test recording area of an inner circumference part in operation S104. Then, the test write area may be overwritten, and an optimum write strategy may be set according to the method explained below in operation S105.

Once the write strategy is set, either via operation S103 or operations S104 and S105, write operation may begin in operation S106. Once the write operation is finished, the control unit 8 may move the optical pickup 2 to the start of the written information and may read the information.

Since a circuit, e.g., a Large Scale Integrated (LSI) circuit, setting a write strategy operates in response to a predetermined clock, the write strategy cannot be changed continuously, i.e., in an analog fashion. Accordingly, the write strategy should be changed discretely, with one clock pulse being a minimum change quantity. This minimum change quantity is referred to as a minimum resolution. That is, information is written according to a changed write strategy based on the reference write strategy in which predetermined pits and lands are changed by an integer-number of a minimum resolution of the reference write strategy.

During setting of the write strategy, the signal read by the optical pickup 2 may be input to the signal processing unit 4 and converted into an EFM signal. The converted EFM signal may be input to the write strategy setting unit 6. The write strategy setting unit 6 may compare the input EFM signal with the theoretical length of each pit and land input from the ROM 10 through the control unit 8 and may calculate the difference value (deviation value).

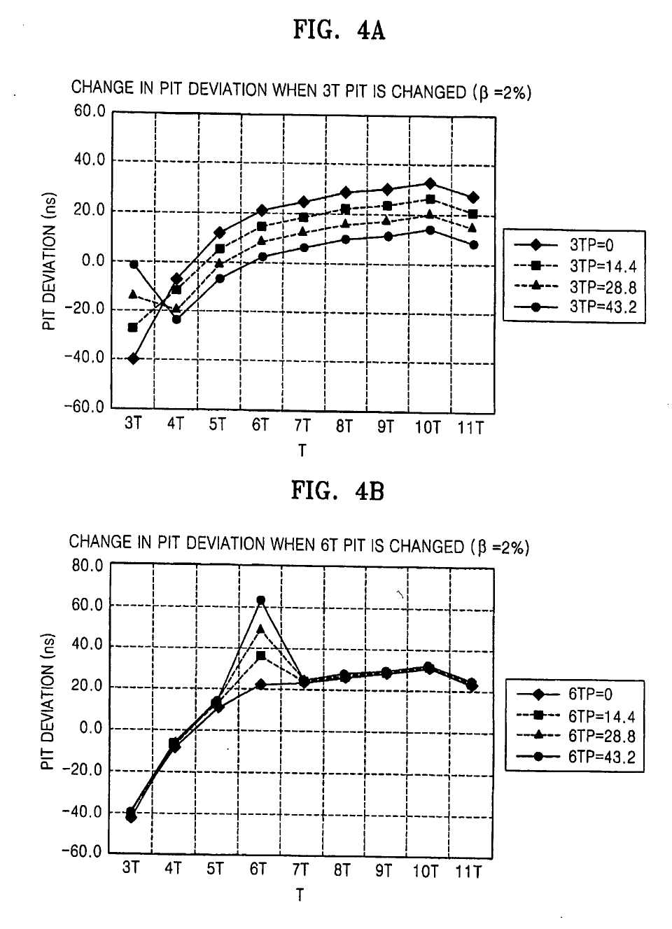

Since the deviation value includes the effect by another pit or land, the degree of the effect when the length of another pit or land is changed may be obtained using the probability of the presence of a combination of each pit and land. Then, by using the degree of the effect, the unique quantity of expansion and contraction of each pit and land may be calculated. A method of calculating the unique quantity of expansion and contraction of a pit and land will now be explained with reference to FIGS. 4A and 4B.

Pits and lands of an EFM signal are formed such that the sum of the pit lengths is the same as the sum of the land lengths. Accordingly, if the length of a predetermined pit (or a land) is changed, the balance of the distribution of the pits and lands is disrupted. To correct this, the entire length of the pits (or lands), including the changed predetermined pit (or land), is changed.

For example, if the length of a predetermined pit is increased, the balance of the distribution of the pits and lands is disrupted. To correct this, the entire length of the pits, including the changed predetermined pit, is decreased. This phenomenon appears as a change in the slice level of an actual reproduction waveform (RF signal).

More specifically, FIG. 4A illustrates changes in length of other pits, i.e., pits from 4 T to 11 T, when only a 3 T pit in an EFM signal is increased by ΔT. In the graph of FIG. 4A, the vertical axis indicates deviation, the horizontal axis indicates pits from 3 T to 11 T, and each curve indicates changes of each deviation when ΔT, which equals 0 ns, 14.4 ns, 28.8 ns and 43.2 ns, is added to 3 T pit, respectively.

Assuming that the probability of the presence of a 3 T pit in an EFM signal is 33%, the relationship with the changed quantity ΔT(4-11 T) from 4 T to 11 T pits may be expressed by equation 1:
ΔT(3 T)×0.33=ΔT(4-11 T)×(1−0.33)
ΔT(4-11 T)=ΔT(3 T)×0.33/(1−0.33) (1)

It can be calculated that the changed quantity from 4 T to 11 T pits is half the changed quantity of the 3 T pit. This result is also supported by the result of actual measurement illustrated in FIG. 4A. Meanwhile, as illustrated in FIG. 4B, it can be demonstrated that when a 6 T pit having a low probability of occurrence is changed in the same manner, the effect to the lengths of other pits or lands is very small.

By using the probability of the occurrence of a combination of each pit and land, the degree of the effect on the lengths of other pits or lands when the length of a predetermined pit or land is changed can be identified.

More specifically, when a recorded signal is reproduced, the written length of each combination of all pits and lands may be measured and the measured results may be stored in the RAM 9. A deviation between the written length when information is written according to the reference write strategy stored in the RAM 9 and the theoretical length of each combination of all pits and lands stored in the ROM 10, a deviation between the written length when information is written according to a write strategy in which predetermined pits and lands are changed by an integer-number of a minimum resolution, and a theoretical length of each combination of all pits and lands stored in the ROM 10 may be calculated. Also, the difference between the two deviations may be calculated. Also, if the quantity of expansion from a 3 T pit to a 5 T pit before a 3 T land to a 5 T land with respect to the reference write strategy is an integer-number of a minimum resolution, the obtained deviation value may be divided by the integer value and may be determined as the deviation value with respect to the minimum resolution.

In order to calculate the unique quantity of expansion and contraction of each pit and land from the calculated deviation value, the probability of the occurrence of each combination of pits and lands may be used. For example, the unique quantity of expansion and contraction of a combination of a 3 T pit and a 3 T land may be obtained by removing the effect by changes in other pits and lands from the deviation value at the combination of the 3 T pit and 3 T land. Accordingly, assuming that unique quantities of expansion and contraction of combinations of a 3 T pit and a 3 T land, a 4 T land, and a 5 T land are ΔT(3,3), ΔT(3,4) and ΔT(3,5), respectively, and probabilities of the presence of the combinations are R(3,3), R(3,4) and R(3,5), respectively, and the deviation value of a 3 T pit and a 3 T land is A, the relation may be expressed as the following equation 2:
ΔT(3,3)−ΔT(3,4)×R(3,4)/(1−R(3,4))−ΔT(3,5)×R(3,5)/(1−R(3,5))=A (2)

In a combination including a 6 T pit or a 6 T land, a deviation value close to each combination exists, though the 6 T pit or land does not change.

This deviation may be generated through accumulation of the effects of changes in the length from a 3 T pit to a 5 T pit before a 3 T land to a 5 T land.

Accordingly, assuming that the deviation value of a 3 T pit and a 6 T land is Z, Z may be expressed by equation 3 and equation 3 may be substituted into equation 2 to obtain equation 4. Likewise, the unique quantity of a combination of each pit and land can be obtained from the probability of the occurrence of the combination.

$$\begin{matrix}Z = Δ T ( 3 , 3 ) ⨯ R ( 3 , 3 ) / ( 1 - R ( 3 , 3 ) ) + Δ T ( 3 , 4 ) ⨯ R ( 3 , 4 ) / ( 1 - R ( 3 , 4 ) ) + Δ T ( 3 , 5 ) ⨯ R ( 3 , 5 ) / ( 1 - R ( 3 , 5 ) ) & ( 3 ) \\ Δ T ( 3 , 3 ) = ( Z + A ) ( 1 - R ( 3 , 3 ) ) & ( 4 )\end{matrix}$$

Once the unique quantity of the combination of each pit and land is obtained, a write strategy minimizing this quantity may be obtained in operation S103 or operation S105.

Before write strategy setting in operation S105, the optimum write power to be used on the recording medium may be set by performing a test write according to a reference write strategy at a test recording area of an inner circumference part in operation S104. Then, an operation to overwrite information on the part in which the test write may be performed again, and according to the method described above, a write strategy may be set in operation S105.

Accordingly, in the present embodiment, whether an area in which information is desired to be written is a used area or a blank area is determined. If the area is a used area, information may actually be overwritten, then an optimum write strategy may be determined and a write operation may be performed. Accordingly, even in an overwrite operation, the recording quality can be enhanced.

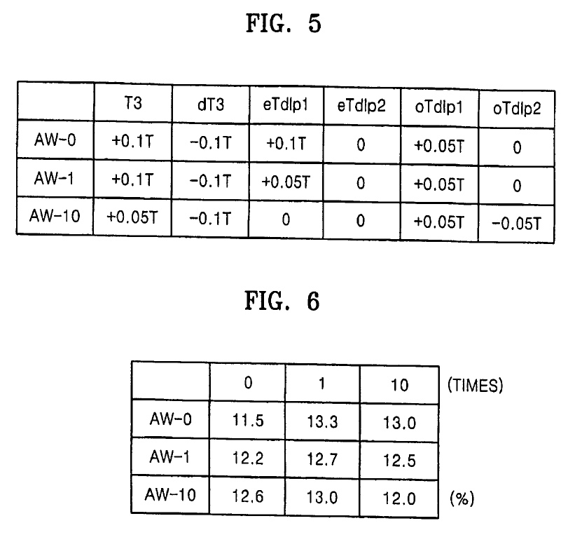

FIG. 5 illustrates an optimum write strategy with respect to a number of overwrite operations when information is written on a DVD-RW according to an embodiment of the present invention.

Referring to FIG. 5, AW-0 indicates optimum write strategies (T3, dT3, eTdip1, eTdlp2, oTdlp1, oTdlp2) when information is to be written in a blank area, AW-1 indicates optimum write strategies when information is to be written in an area having been written to once and AW-10 indicates optimum write strategies when information is to be written in an area having been written to ten times. As illustrated in FIG. 5, it can be seen that differences exist among respective optimum write strategies.

FIG. 6 illustrates changes in jitter values when information is recorded according to the write strategies of FIG. 5 according to an embodiment of the present invention. FIG. 6 illustrates jitter values when information is written according to each write strategy of AW-0, AW-1 and AW-10 in a blank area, in an area in which an overwrite operation has been performed once, and in an area when ten overwrite operations have been performed.

Referring to FIG. 6, when AW-0 is used and a number of overwrite operations in increased, the jitter value deteriorates by up to 13.3% when the one overwrite operation has been performed. When AW-1 or AW-10 is used, and a number of overwrite operations in increased, the jitter value in relation to the frequency of the overwrite operation is reduced. That is, a write strategy for an overwrite operation may be set. By using the set write strategy, recording quality for used areas may be enhanced.

In the present embodiment, an example of setting a write strategy for an overwrite operation performed in a test recording area in an inner circumference of an optical recording medium is described above. However, in another embodiment, if an area in which information is desired to be written is a used area, a test write operation may be performed first in a test recording area of an inner circumference to set a write power and then an overwrite operation may be performed in an area in which a write operation is to be performed. In other words, since the area to be written is already used, the test write operation may be performed on the area. Then, by using the method described above, a write strategy can be set.

Also, the embodiment of the present invention is useful in relation to an area to which information is written once and then erased. Two types of erasing may be employed, i.e., a logical erase and a physical erase. When a logical erase, whether an area is a blank area or a used area that has been erased may not be determined only by reading information on the erased area. Accordingly, in order to determine this accurately, the method of the embodiment of the present invention in which a search operation is performed to read information in an area in which information is desired to be written is useful.

When information is written in a completely blank medium, a write strategy for an overwrite operation may be set in accordance with the present invention and stored in advance, so that the stored write strategy can be used when an overwrite operation is performed.

According to the optical information writing apparatus and method as described above, even when an overwrite operation is performed on a rewritable optical recording medium, a write strategy for the overwrite operation may be set such that the quality of recording can be improved.

Exemplary embodiments of the present invention have been disclosed herein, and although specific terms are employed, they are used and are to be interpreted in a generic and descriptive sense only and not for purpose of limitation. For example, the setting of a write strategy of the present invention may be implemented in software, e.g., by an article of manufacture having a machine-accessible medium including data that, when accessed by a machine, cause the machine to generate writing strategies in accordance with methods of the present invention. Accordingly, it will be understood by those of ordinary skill in the art that various changes in form and details may be made without departing from the spirit and scope of the present invention as set forth in the following claims.

What is claimed is:

1. An optical information writing method, comprising:
determining a written state of an area of an optical recording medium in which information is to be recorded; and
setting a write strategy in accordance with the written state of the area to be recorded.

2. The method as claimed in claim 1, wherein, when the written state of the area is used, the method further comprising performing an overwrite operation before setting the write strategy

3. The method as claimed in claim 2, wherein performing the overwrite operation includes overwriting information in a test recording area of the optical recording medium.

4. The method as claimed in claim 2, wherein performing the overwrite operation includes overwriting information on the used area in which information is to be recorded.

5. The method as claimed in claim 2, further comprising determining a write power.

6. The method as claimed in claim 5, wherein determining the write power occurs before performing the overwrite operation.

7. An optical information writing apparatus, comprising:
a written state determination unit for determining a written state of an area of an optical recording medium in which information is to be recorded; and
a write strategy setting unit for setting a write strategy in accordance with the written state of the area to be recorded.

8. The apparatus as claimed in claim 7, wherein, when the written state of the area is used, the write strategy setting unit performs an overwrite operation before setting the write strategy.

9. The apparatus as claimed in claim 8, wherein the write strategy setting unit performs the overwrite operation in a test recording area of the optical recording medium.

10. The apparatus as claimed in claim 8, wherein the write strategy setting unit performs the overwrite operation on the area to be recorded.

11. The apparatus as claimed in claim 8, wherein the write strategy unit determines a write power.

12. The apparatus as claimed in claim 11, wherein the write strategy unit determines the write power before performing the overwrite operation.

13. An article of manufacture having a machine-accessible medium including data that, when accessed by a machine, cause the machine to operate an optical information recording apparatus, the operation comprising:
determining a written state of an area of an optical recording medium in which information is to be recorded; and
setting a write strategy in accordance with the written state of the area to be recorded.

14. The article as claimed in claim 13, wherein the operation further comprises, when the written state of the area is used, performing an overwrite operation before setting the write strategy.

15. The article as claimed in claim 14, wherein performing the overwrite operation includes overwriting information in a test recording area of the optical recording medium.

16. The article as claimed in claim 14, wherein performing the overwrite operation includes overwriting information on the used area in which information is to be recorded.

17. The article as claimed in claim 13, wherein the operation further comprises determining a write power.

18. The article as claimed in claim 17, wherein determining the write power occurs before performing the overwrite operation.
